(19) United States
(12) Patent Application Publication
(10) Pub. No.: US 2010/0207722 A1
(43) Pub. Date: Aug. 19, 2010

(54) Wireless passive keyless entry system with touch sensor

(75) Inventor: Mark Rutledge, Murrieta, CA (US)

Correspondence Address: KC Bean, 2404 Margie Way, Vista, CA, 92084, US

(73) Assignee: Mark Rutledge

(21) Appl. No.: 12/658,983

(22) Filed: Feb. 18, 2010

Related U.S. Application Data
(63) Continuation-in-part of application No. 12/260,364, filed on Oct. 29, 2008.

(51) Int. Cl. H04B 1/034

(52) U.S. Cl. 340/5.51

(57) ABSTRACT

A passive keyless entry system is provided comprising a wireless touch sensor, a one way RF transmitter capable of transmitting an identification and proximity signal, a system, a sensor antenna connected to the system that receives a touch sensor signal from the wireless touch sensor, and a RF transmitter antenna connected to the system that receives encoded identification and proximity signals from the RF transmitter. The system unlocks a locking mechanism when both the touch sensor signal and the RF transmitter signals are received and authorized by the system.

### REFERENCE TO RELATED PATENTS

This application is a continuation-in-part of application Ser. No. 12/260,364, titled Wireless Touch Sensor, filed on Oct. 29, 2008, which is incorporated herein by reference in its entirety.

### FIELD OF THE INVENTION

The field of the invention is a passive keyless entry system.

### BACKGROUND

Keyless entry systems are known that utilize a key fob, user held remote control unit, or other radio frequency transmitter device in the possession of the user to communicate with an automobile, building or other product with an access entry point, and unlock the entry point. Actuation is typically accomplished by pushing a button on the transmitter. While using a remote is often more convenient than using a key, the user still requires a free hand to operate the remote. Thus, the user held remote, like a key, still requires an extra step by the user to unlock the door.

One solution that eliminates the extra step uses proximity detection systems. Such systems typically use a cell phone or other signal-emitting portable device, and are known to operate on many different frequencies and protocols, including for example UHF, Bluetooth, and radar. One problem with proximity detection is that the signal detection range can vary greatly from system to system, especially in aftermarket applications where environmental and installation factors can vary greatly. Another problem is that known proximity detection systems tend to trigger a locking mechanism to unlock each time a user is within range of the detection system. Thus, in a poorly configured system, a door might well unlock when the user is within the detection range, whether or not the user intended it.

Another solution provides for an encoded transponder or other type of RF ID tag and a power emitting module with a receiver near the entry point that transmit energy to the transponder, and where the transmitter absorbs the energy and transmits an identification or access authorization code back to the module receiver. This type of system is limited in that the module must constantly transmit a signal to query the transponder and allow the transponder to reply with an identification signal back to the module. This requires the system to use more power than is desirable. These systems typically operate at 125 KHZ, with resulting low range. While these low frequency systems result in good control of range, it does not integrate well with aftermarket systems, which typically operate at 434 MHZ. Such a system creates significant installation limitations for aftermarket applications.

Passive keyless entry systems have the advantage of eliminating the step of actively engaging the user held remote altogether. For example, U.S. Patent App. no. 2006/0232378 to Ogino (pub. October 2006) teaches a piezoelectric sensor that cooperates with a keyless entry system to prevent unintended opening of the vehicle. That resolves some of the problems listed above, but requires extensive wiring, and therefore must typically be factory-installed. For a structure it must be planned into the design at the time of construction. Among other things, such systems often require wiring to a powered, high frequency antenna as well as to a wired touch sensor at each entry point. These assemblies can require power and ground connections, as well as wiring to a main module to process the detected signals. Thus, the cost for the extensive wiring generally prohibits aftermarket installation.

Ogino and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for a passive keyless entry system with a wireless touch sensor that avoids the need for excessive power use, additional wiring and any active signaling by the user to unlock the access point door. The system also greatly reduces the complexity and expense for aftermarket applications.

### SUMMARY OF THE INVENTION

In one aspect, the inventive subject matter provides apparatus, systems, processes, and methods in which a passive keyless entry system comprises a wireless touch sensor, a user held transmitter of transceiver, and one or more antennas.

Advantageously, the touch sensor is wirelessly connected to the keyless entry system. The wireless aspect can greatly reduce the time required and cost for installation on an after-market basis, since no external wiring is needed. Installation of the touch sensor only requires mounting it to any suitable surface including, which could, for example be a door, a door handle, a mirror, a hood, a gas tank door or a trunk lid. The touch sensor can be powered using a standard coin sized battery which can be replaced periodically or designed to operate for the life of the product in a sealed enclosure, or it could be a conductive loop that allows for transduction of electric current.

All manner of radio frequency communications are contemplated as the signaling means for identifying the properly associated user held transmitter that is uniquely encoded with an identifier to be programmed into the keyless entry system and transmitting a proximity signal for unlocking the entry point.

All antennas suitable to receiving a signal from the RF transmitter signaling device and/or the touch sensor are contemplated. While multiple antennas can be used, a single antenna provides for quicker and less costly installation. Preferably, the installer will use an existing antenna of a security system or other wireless communication device, thereby eliminating the cost of installing a second antenna. The user held transceiver or touch pad transmitter may be uniquely programmed into the memory of the keyless entry system, avoiding unauthorized entry from errant signals received from unpaired transmitters.

In preferred embodiments, the keyless entry system cooperates with an existing security system that acts to control a locking mechanism of the access point. For example, the keyless entry system might utilize the existing antenna and receiver of a home or vehicle security system, such that installation requires little more than reprogramming the security system to respond to signals from the user held transceiver and touch sensor of the passive keyless entry system. This can significantly reduce hardware and labor costs. However, it will be recognized by those skilled in the art that the passive keyless entry system of the invention is suitable for use with any product that has an entry or access point, such as a refrigerator or other appliance, a garage door system, a safe, etc.

In the preferred embodiment, the passive keyless entry system comprises a transceiver held by or located with the user that sends a wireless one way identification and proximal location signal to the receiver of the keyless entry system located in the vehicle, and a wireless touch sensor that wirelessly transmits a signal to the receiver. A one way signal from the hand held transceiver is preferable because it eliminated the need for the module located near the access point to constantly transmit a query signal to an RF ID tag which is detected and replied to with a signal, thus saving power. The transceiver can use a number of power management system to reduce power consumption, including a “transmit on motion only” type of system. Once the signals of the user held transceiver and the touch sensor are received by the keyless entry system and the verification of the properly encoded identification signal is made, a locking mechanism unlocks the door access point, and may open the door via an opening mechanism. Timely receipt is contemplated to be within one second to one-minute period, and preferably within about 1 to 10 seconds; however, the period can be adjusted as needed to balance the competing needs of and convenience. The power output of the user held RF transmitter can be adjusted to set a local proximity radius around the access point of the vehicle, building, or product to allow for increased or decreased distance which the keyless entry system will respond to the RF transmitter.

Passive keyless entry systems according to the teachings herein can be used in fixed structures, including for example homes, offices, or other buildings, and can also be adapted to movable structures, including for example, cars, boats, trucks, and so forth. Conversion kits for existing structures, especially cars and trucks, are especially contemplated.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a passive keyless entry system for a vehicle.

FIG. 2 is a schematic of a passive keyless entry system for a building.

FIG. 3 is a flowchart for a method for facilitating unlocking of a door without a key.

FIG. 4 is a flowchart for a method of converting an enclosure to respond to a portable transmitter carried on a person.

### DETAILED DESCRIPTION

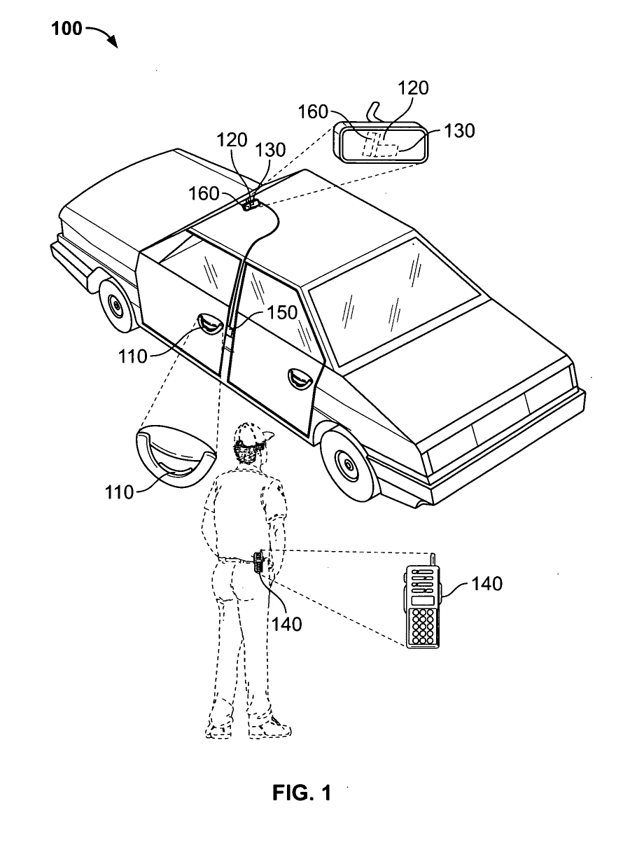

In FIG. 1 a passive keyless entry system 100 for a vehicle generally includes a wireless touch sensor 110, a user held transceiver 140, a sensor antenna 120, a door lock mechanism 150, a system antenna 160, and a security system 130.

Wireless touch sensor 110 is preferably self-contained and lacks any external wiring. For example, the wireless touch sensor might be sealed and disposable, but might instead have a user-serviceable battery (not shown) or a transduction circuit that allow recharging from local electrical emissions. Wireless touch sensor 110 is uniquely paired to the keyless entry system by entering the programming mode of the system and transmitting from the wireless touch sensor a unique identification code representing the specific individual wireless touch sensor that is recorded into the memory (not shown) of the keyless entry system. Wireless touch sensor 110 is preferably sized to be discretely mounted. For example, wireless touch sensor 110 could be sized to mount to an inside of a door handle on a vehicle. Thus, the wireless touch sensor 110 could be placed in a variety of locations on the vehicle or building to be hidden from a passerby and not detract from the vehicle's appearance.

Wireless touch sensor 110 can comprise any type of sensor associated with a transmitter that wirelessly transmits an encoded identification or authorization signal when actuated. Contemplated touch sensors include, for example a capacitive touch sensor, a fingerprint sensor and a push button sensor. Preferably, touch sensor 110 can be actuated and transmit a signal when a finger is pressed against the touch sensor. Because wireless touch sensor 110 lacks external wiring, the signal must be transmitted wirelessly, either directly or indirectly to sensor antenna 120. For example, wireless touch sensor can indirectly transmit a signal to a repeater (not shown) that transmits the signal to the sensor antenna 120.

RF transmitter 140 can be a user held one way or two way radio frequency (RF) transceiver. The contemplated RF transmitter 140 include passive RF transmitter that transmits to the systems antenna 120 an encoded signal encoding a unique identifier representing the identity of the particular RF transmitter that has been paired to the keyless entry by entering the programming mode of the keyless system and transmitting the coded signal from the RF transmitter until it is accepted into the memory of the keyless entry system.

Preferably, RF transmitter 140 transmitter incorporates a motion sensor that triggers the one way transmission of a coded signal only when the RF transmitter 140 is in motion when in th possession of the user. Transmission of a signal only while in motion prevents continuous signal transmission and the related consumption of power. The motion sensor can be a piezo, hall effect, or other type of sensor capable of detecting motion; many are well known in the art. Additionally, it is preferable to limit the power output of the one way transmission such that the coded signal is only received by the antenna 160 when the RF transmitter 140 is in relatively close proximity of the touch sensor 110. The power output of the RF transmitter 140 may be adjusted to select a range that is preferable to the user. Preferably this would be an existing RF transmitter with simple software programming to enable periodic transmission.

In one aspect, RF transmitter 140 is sized to be portable and user carried. Preferably, RF transmitter 140 can be sized to fit inside of a pocket, wallet or a purse for a vehicle application. More preferably, RF transmitter 140 can be sized to be no greater in size than a standard key fob that is widely known. Most preferably, RF transmitter 140 can be sized to fit inside of a cellular telephone or other similarly sized device. For example, a user can carry a cell phone embedded with RF transmitter and unlock the doors by simply coming into proximity of the door and then actuating the touch sensor 110. Thus, RF transmitter 140 can be discretely carried and eliminate the need to carry additional items including keys and a keyfob or other remote.

Sensor antenna 120 can be any antenna capable of receiving an encoded sensor signal from wireless touch sensor 110. RF transmitter antenna 160 can be any antenna capable of receiving an encoded signal from RF transmitter 140. Both antennas can be functionally coupled to the system 130 and thereby communicate the signals to the system 130.

Preferably, touch sensor antenna 120 and RF transmitter antenna 160 can be a single antenna. More preferably, the passive keyless entry system 100 can utilize the vehicle's existing antenna (not shown) to function as touch sensor antenna 120 and RF transmitter antenna 160. Thus, the keyless entry system would require fewer components, which reduces the installation and overall system costs.

Security system 130 can be any suitable system that acts to control locking mechanism 150 and unlock a door when both the touch sensor signal and the RF transmitter signal are received. Preferably, security system 130 can be an existing security system of the vehicle.

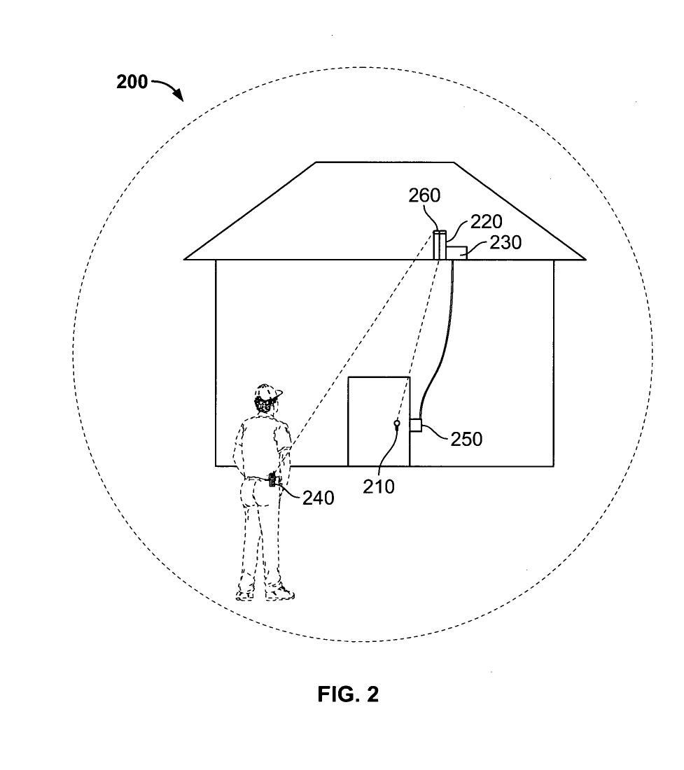

FIG. 2 illustrates a passive keyless entry system 200 for a building comprising a wireless touch sensor 210, a RF transmitter 240, a touch sensor antenna 220, an RF receiver antenna 260, and a system 230 that controls a locking mechanism 250. In other contemplated embodiments, the passive keyless entry system 200 can be used in any application having a similar access control requirement, including fixed structures, including for example homes, offices, or other buildings, and movable structures, including for example, cars, boats, trucks, and so forth.

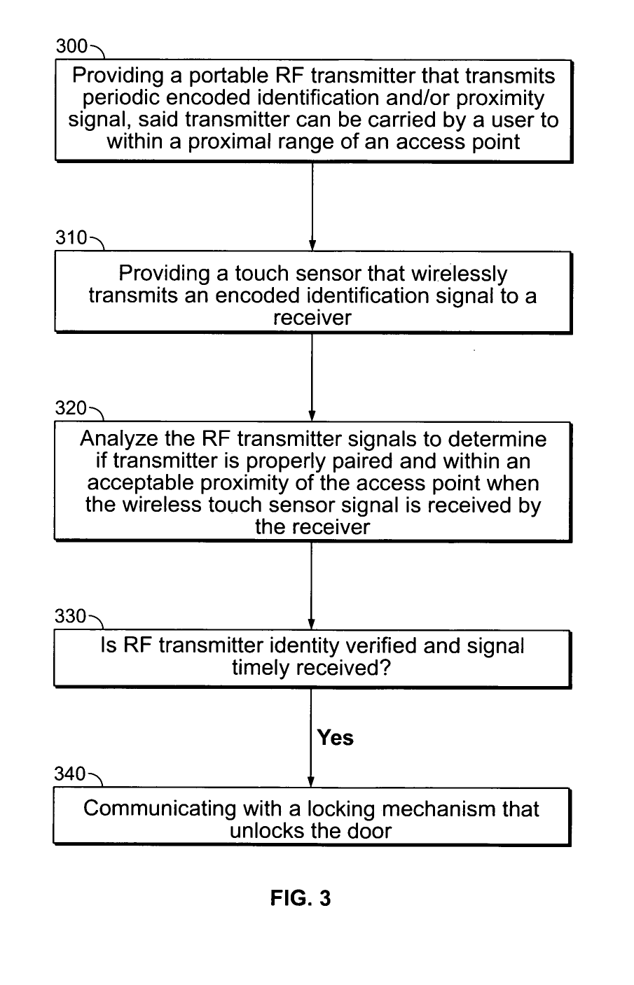

FIG. 3 depicts a method for facilitating unlocking of a door without requiring the insertion of a key. The method includes the step 300 of providing a portable RF transmitter that can be carried by a user within a signal detection range of an access point. Preferably, the signal detection range system is configured to be the transmission range of the RF transmitter. If the RF transmitter is within the signal detection range and the touch sensor is triggered to a signal to a system controller at step 310 the method will move to step 320. If the touch sensor signal is within a predetermined time period from receiving the RF transmitter coded signal of step 300, at step 320 an analysis is made of the RF transmitter signal to determine if the RF transmitter is properly paired to the system and within range of the access point when a touch sensor signal is received. At step 330 the system clock compares the difference in time between receipt of the RF transmitter signal and the touch sensor signal. At step 340, if the identity and the signal timing is appropriate an unlock message will be wirelessly sent by the system module to the access point locking mechanism and door opening mechanism.

Electronics are provided that allow wireless transmission of a coded signal from a touch sensor to a receiver 320. The system then determines if the signal is from the authorized touch sensor and was timely received after the RF transmitter signal has been verified 330. Timely receipt is preferably within three seconds of receiving the signal from the RF transmitter. If the signal is timely received, the system instructs a door locking mechanism to unlock the door 340. If the signal is not timely received or it is determine by the system to be in an unacceptable proximity, the system ignores the signal.

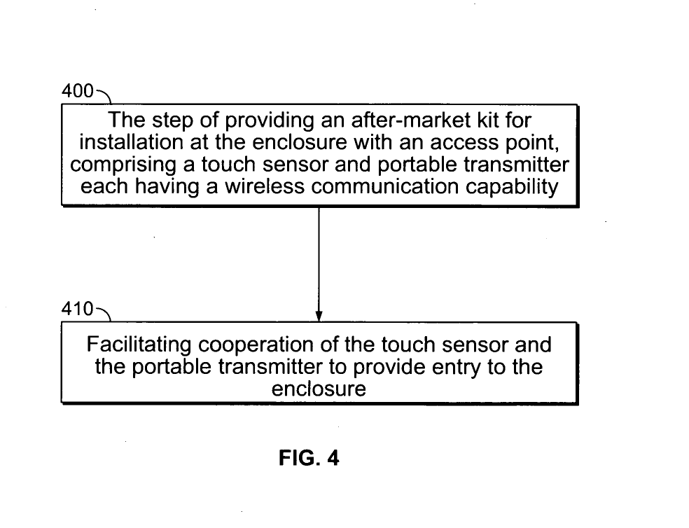

FIG. 4 depicts a method for converting an enclosure with an access point to respond to a portable transmitter carried on a person in conjunction with a wireless touch sensor. Initially, an after-market kit is provided for installation at the enclosure 400. The kit can comprise a keyless entry RF transmitter and a touch sensor having a wireless communication capability. Once installed, cooperation of the touch sensor and the portable transmitter can be facilitated to allow entry to the enclosure after close proximity and temporal activation of the touch sensor and the portable RF transmitter 410. Close proximity can be any reasonable distance from the access point that allow hands free entry and temporal activation can be any reasonable period of time between the activation of the touch sensor and portable RF transmitter, and is preferably a period of less than 60 seconds, and more preferably between 1 and 10 seconds.

The touch sensor can preferably be installed at a door of the vehicle or other enclosure including, for example within a door or door handle, and on a door or door handle. The touch sensor can be built into the lock mechanism or cylinder such that a touch of the door handle will trigger the transmission of the entry authorization signal. Alternatively, the touch sensor can be installed on a surface of the vehicle or other secured building or structure.

In a preferred embodiment, cooperation can be facilitated by converting a pre-conversion access point to respond to signals received from the touch sensor and portable transmitter. The pre-conversion access point can be a system of the enclosure that existed prior to the touch sensor's installation. Converting the system can be accomplished through hardware and/or software updates. Preferably, software of the pre-conversion system allows for programming, into system memory, RF transmitter and touch sensor identification encoded signals such that RF transmitter and touch sensor are paired to the system. This allows for easy retrofitting and replacement of portable RF transmitter and touch sensor if lost or damaged. In various embodiments, the pre-conversion of the access point can be utilized to unlock at least one of a driver door, a passenger door, a gas tank door, a trunk, and a hood, if installed in a vehicle or a window, door, or garage door if installed in a building.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A keyless entry system, comprising:
a wireless touch sensor, in proximity to an access point where said access point is associated with a locking mechanism;
an RF transmitter that is physically separated from the wireless touch sensor;
a system that controls said locking mechanism;
a touch sensor antenna functionally coupled to the system, and receives a sensor signal from the wireless touch sensor;
an RF transmitter antenna connected to the system that receives a proximity signal from the RF transmitter, wherein the system acts to unlock the locking mechanism when both the sensor signal and the RF transmitter proximity signal are received and authorized by the system.

2. The keyless entry system of claim 1, wherein the system acts to unlock the locking mechanism when the system receives a touch sensor signal within a period of time from receiving an encoded RF transmitter proximity signal.

3. The keyless entry system of claim 1, wherein the system acts to unlock the locking mechanism when the system receives an encoded sensor signal within a predetermined time from receiving an RF Transmitter signal.

4. The keyless entry system of claim 1, wherein the system acts to unlock the locking mechanism when receipt of the sensor signal overlaps at least partially with receipt of the RF transmitter proximity signal.

5. The keyless entry system of claim 1, wherein the RF transmitter and the touch sensor wirelessly transmits an encoded signal with a unique identifier sequence that is programmed into the memory of the keyless entry system and allowing the keyless entry system to recognize the received signal as authorized.

6. The keyless entry system of claim 1, where said touch sensor antenna and said RF transmitter antenna are integrated in a single antenna.
The keyless entry system of claim 1, were said touch sensor and RF transmitter transmit one way encoded signals.

7. The keyless entry system of claim 1, wherein the wireless touch sensor is disposed on an automotive vehicle.

8. The keyless entry system of claim 1, wherein the wireless touch sensor is disposed on a building.

9. The keyless entry system of claim 1, wherein the wireless touch sensor is battery powered.

10. The keyless entry system of claim 1, wherein the wireless touch sensor is powered by a transduction circuit.

11. A keyless entry system, comprising:
a wireless touch sensor, proximal to an access point where said access point is associated with a locking mechanism, and where said wireless touch sensor transmits an encoded identification signal that has been paired to the keyless entry system;
an RF transmitter that is physically separated from the wireless touch sensor where said RF transmitter transmits an encoded identification signal to the keyless entry system;
a system that controls said locking mechanism;
a touch sensor antenna functionally coupled to the system, and receives a touch sensor identification signal from the wireless touch sensor;
an RF transmitter antenna connected to the system that receives a proximity signal and a encoded identification signal from the RF transmitter, wherein the system acts to unlock the locking mechanism when both the touch sensor signal and the RF transmitter encoded identification and proximity signals are received and authorized by the system.

12. The keyless entry system of claim 11, where the system acts to unlock the locking mechanism only if the encoded identification signals received from the touch sensor and the RF transmitter are received sequentially within a predetermined period of time.

13. The keyless entry system of claim 11, where the system acts to unlock the locking mechanism only if the encoded identification signals received from the touch sensor and the RF transmitter are recognized as authorized.

14. The keyless entry system of claim 11, where the encoded identification signals of the touch sensor and the RF transmitter are paired with the keyless entry system by programming said identification signals into the memory of the keyless entry system.

15. A method for unlocking a door without requiring insertion of a key into a keyway, comprising;
providing a portable RF transmitter that can be carried to within a wireless detection range of a system;
providing electronics that includes a touch sensor and a RF transmitter that wirelessly transmits a encoded signal to a receiver; and
communicating with a locking mechanism of said system that unlocks the door upon verification of the touch sensor and RF transmitter encoded identification signals and timely receipt of said signals.

16. The method of claim 15, wherein the touch sensor and RF transmitter transmits an encoded signal identifying said touch sensor and RF transmitter as authorized.

17. The method of claim 15, wherein timely receipt is less than one minute.
